(19) United States
(12) Patent Application Publication
(10) Pub. No.: US 2023/0177595 A1
(43) Pub. Date: Jun. 8, 2023

(54) VIRTUAL PRODUCT ARRANGEMENT

(71) Applicant: Party City Holdings Inc., Rockaway, NJ (US)

(72) Inventors: Julie Roehm, Elmsford, NY (US); Shannon Symalla, Elmsford, NY (US); Heather Liang, Elmsford, NY (US)

(21) Appl. No.: 18/075,869

(22) Filed: Dec. 6, 2022

Related U.S. Application Data
(60) Provisional application No. 63/286,171, filed on Dec. 6, 2021.

(51) Int. Cl. G06Q 30/0601; G06F 3/0482; G06F 3/04845

(52) U.S. Cl. CPC G06Q 30/0643; G06F 3/0482; G06F 3/04845

(57) ABSTRACT

In one or more particular arrangements, a computer implemented process is provided that allows for a user to generate a virtual arrangement of bouquet items. In one particular implementation, a processor is configured to provide a user, remote from the processor, with one or more data values, where each of the one or more data values corresponds to a virtual bouquet generation process. Upon receiving a selection from the user of one of the one or more data values, the processor is configured to either generate a pre-determined virtual product bouquet or provide the user with bouquet components that can be virtually assembled into a custom bouquet.

### CROSS REFERENCE TO RELATED APPLICATION

The present application claims the benefit of U.S. patent application Ser. No. 63/286,171, filed Dec. 6, 2021, which is hereby incorporated by reference in its entirety.

### FIELD OF THE INVENTION

The present invention is directed to systems, processes and computer implemented methods of generating and arranging virtual representations of product offerings.

### BACKGROUND OF THE INVENTION

Existing digital and eCommerce technology in the party supplies space is exclusively transactional in nature. Websites typically provide customers with digital catalogs of individual product SKUs that the user then selects from when sourcing party supply packages. While artificial intelligence and eCommerce can be used for merchandise sorting and filtering of SKUs based on customers' input, event and party products are ultimately presented as product cards, images in a product grid landing configuration, or on a product detail page.

Often, consumers of party supply products initiate their party planning journey with a style and design vision. They seek to curate an assortment of products to bring a party vision to life. Using product grid pages, or physical product packaging in a physical store environment, customers must envision how the product might come to life outside of packaging. Such tasks become more complex when paired with other products with similar attributes, or when the user attempts to envision how an inflated balloon bouquet or balloon garland will look. While some customers can envision such arrangements, it can be difficult to keep track of how an arrangement will look as it grows in complexity.

Therefore, what is needed in the art are systems, processes, and computer implemented methods that permit the user to view, manipulate and arrange custom and stock elements in a virtual environment. Using this virtual environment, the user can identify ideal arrangements, colors, sizes, and customizations of a product prior to purchase. Furthermore, what is needed in the art are systems, processes and computer implemented methods that can dynamically alter arrangements based on the user selections and consider visibility of desired items when dynamically altering arrangements.

### SUMMARY

In one or more particular arrangements, a computer implemented process is provided that allows for a user to generate a virtual arrangement of bouquet items. In one particular implementation, a processor is configured to provide a user, remote from the processor, with one or more data values, where each of the one or more data values corresponds to a virtual bouquet generation process. Upon receiving a selection from the user of one of the one or more data values, the processor is configured to either generate a pre-determined virtual product bouquet or provide the user with bouquet components that can be virtually assembled into a custom bouquet.

Once the user has selected or generated a virtual bouquet that meets the needs of the user, the processor translates the virtual bouquet into one or more instructions or instructions sets that can be provided to one or more manually or automatically operated product production facilities where a physical representation of the virtual bouquet is created or stored. In one or more particular implementations, an automatic product manufacturing process is used to generate each of the individual components of the bouquet, which are then packaged and transported to the end user for assembly in accordance with the virtual representation.

In one or more particular implementations, a processor is configured by one or more modules executing as code therein to present a user with one or more event types as user interface elements. Upon receiving an event type selection from the user, the processor is configured to generate a virtual environment for display to the user. Here, the virtual environment displayed corresponds to the event type selection made by the user. The processor is further configured to access an inventory management system to obtain an array of available products having a corresponding virtual environment representation. In one or more implementations, the array of available products includes groups or collections of products that have been tagged or coded as corresponding to the selected event type.

The processor is further configured to present a dynamic three-dimensional environment to the user that enables the user to obtain different views and orientations of the virtual environment. In a particular implementation, the processor (or collection of processors) is configured to allow the adjustment and placement of one or more virtual representations of the array of available products within the virtual environment. For example, a virtual representation of a user's home can be provided, where the virtual environment locates various virtual representations of goods in particular areas of the virtual environment (such as balloon arches over doors).

In one or more particular implementations, a virtual arrangement generation process is provided, the process comprising sending, to a remote user, a collection of user interface elements, wherein each user interface element corresponds to a physical product available for sale and incorporation into an event display. The process further includes receiving from the remote user, a first selection of at least one user interface element. The process also includes generating a virtual, 3-dimensional environment, wherein the environment includes a virtual representation of at least one physical product corresponding to a received user interface selection and receiving a request from the user to add at least one additional representation of at least one additional physical product to the virtual environment. In one or more further implementations, the process includes adjusting at least one parameter of the at least one additional representation of the added physical product, wherein the adjustment is selected to enhance the visibility of at the first selection and at least one additional representation relative to an unenhanced arrangement. In yet a further implementation, the process also includes generating a datafile including each representation of the at least one physical product depicted within the virtual environment, wherein the datafile includes the adjusted parameter for the at least one additional representation of the at least one additional physical product. The process further includes sending the data file to at least one remote production device, wherein the production device is configured to receive the datafile and generate the corresponding physical product, wherein the physical product has the parameters provided in the generated datafile.

### BRIEF DESCRIPTION OF THE DRAWINGS

The present invention may be best understood by reference to the following drawings which are meant to be exemplary and not limiting, in which like references are intended to refer to like or corresponding parts and which:

FIG. 1 provides a system configuration to carry out the processes and methods described herein.

FIG. 2 provides a block diagram of a particular implementation of the system described.

FIG. 3 provides a block diagram of particular elements of the system described.

FIG. 4 provides an illustration of particular elements of the system described.

FIGS. 5A-C provides a table and diagram of a particular implementation of the system described.

FIGS. 6A-B shows an example of a particular user interface elements associated with the system described.

FIG. 7 shows an example of a particular user interface elements associated with the system described.

FIGS. 8A-8D shows an example of a particular user interface elements associated with the system described.

FIG. 9 shows an example of a particular user interface elements associated with the system described.

FIG. 10 shows an example of the virtual environment associated with the system described.

FIG. 11A-D shows an example of a flow diagram detailing processes associated with the lead generation system described.

### DETAILED DESCRIPTION OF ONE OR MORE EMBODIMENTS

By way of broad overview and ease of description, in one or more particular arrangements, a computer implemented process is provided that allows for a user to generate a virtual arrangement of bouquet items or other event decoration items. In a particular implementation, a processor provides a user with one or more selectable user interface elements that correspond to different event themes or event types. Upon selection of one of the pre-determined event themes or types, a virtual environment is generated and populated with one or more discrete virtual items that correspond to the available physical item inventory. The user is enabled, through interaction with the processor, to alter the properties, number and placement of each virtual item displayed within the virtual environment.

Upon the user's selection, one or more physical items that correspond to the virtual items displayed within the virtual environment are generated, and/or shipped to the user for use in the desired event. For example, in one particular implementation, where the user has customized one or more virtual items in the environment, the processor is configured to cause a product customization or generation device accessible over a network to generate one or more physical copies of the custom virtual item. Here, once the user has generated a virtual bouquet or arrangement that meets the needs of the user, the individual components of the bouquet or arrangement are assembled or automatically generated based on the virtual representation.

It will be appreciated by those possessing an ordinary level of skill in the requisite art that existing digital and eCommerce technology in the party supplies space is exclusively transactional in nature. Current systems provide customers with digital catalogs of individual SKUs to select from in building party supply packages. While artificial intelligence and eCommerce merchandising sort and filter SKUs based on customers input, products are ultimately presented as product cards in product grid landing or detail page. Often consumers of party supply products initiate their party planning journey with a style and design vision and seek to curate an assortment of product to bring a party vision to life. With product grid pages, or physical product packaging in a physical store environment, customers must envision how the product might come to life outside of packaging, when paired with other product with similar attributes, or when inflated into a balloon bouquet or balloon garland.

The presently described systems, computer implemented processes and methods overcome this drawback in the art and solve the gap between party idea and product grids, providing a customer a digital “canvas”, or virtual environment, in which to “build” a party collection based on preferred party theme and style. By way of a non-limiting example, users, with access to multiple user inputs, are able to see, through one or more remote devices, what an inflated balloon bouquet will look like on a table in their dining room. Users, in one or more implementations, are able to add and delete products into a virtual space. By manipulating virtual objects within a virtual event space, the user is able to determine how a total party package comes together. This represents both a technical improvement (rendering representational objects in 3 dimensions is a closer analog to how the products will actually interact with the environment) and presents a more intuitive approach for users relative to viewing products as grids or in an ecommerce shopping basket.

As such, the user experience provided by the present described system includes several advantages to the user, including (1) improved product fulfillment accuracy that is realized through descriptive visions of customer's inflated bouquets or party arrangements for execution by team members; (2) increase in customer lifetime value, realized through reduction in customer effort and an additional value proposition for planning more parties; (3) increased business KPIs including sales through guided “digital building” experiences, artificial intelligence (AI) driven attribution and upsell/cross sell opportunities; and (4) expands CLIENT sales channels into mass, grocery, other direct to consumer channels through differentiated value offering.

In additional to the improvements to the user's satisfaction in the party planning arts, the described systems, computer implemented methods and processes also provide with technological improvements to the party planning and purchasing process. For example, the described approach is configured to allow the users to browse a smarter, narrower product assortment curated based on the application of AI to a customer's inputs. For example, the system described herein is able to identify products, product types or classes of goods from a user defined collection of images (such as a ‘mood board’) and identify inventory products that provide the same or similar visual elements. For example, the system provided herein is configured to obtain from a social media board, (i.e. Pinterest) or a mini-survey build a custom party theme or schema. The described system is then configured to generate, a visual representation of party elements within a defined environment space. In a further arrangement the visual representation of party element can be adjusted or revised by adding and removing individual components of the party elements to obtain a cohesive or desired visual impression. Upon selection of the desired party element, a processor is configured to instruct one or more physical warehouse or manufacturing agents to supply or make a product package, including balloons, that when constructed, will provide the real-world.

For example, in one or more particular implementations, the virtual environment allows for a number of balloons (such as 12 balloons) be virtually arranged into a virtual bouquet or presented as one or more selected components on a virtual environment, such as a virtual tablespace. This virtual environment provides multiple benefits over traditional product displays. For instance, the virtual environment allows for the user to view the combined collection of desired products as a unified whole as opposed to seeing single product SKUs in a product grid list.

In another configuration, the described approach allows for a product grouping, such as but not limited to balloons, based on one or more predefined algorithms which consider product attributes including but not limited to size, proportion, material, and color to determine the optimal grouping within the virtual arrangement. Furthermore, by providing a virtual environment, the described system, process, or computer implemented methods leverage augmented reality to show the user the product assortment, i.e.: a table setting, candy buffet, or inflated balloon bouquet in the user's own physical party environment. For example, the systems described herein are able to receive uploaded image(s) that enables users to share a custom designed party package, including inflated balloon bouquet or garland, within personal or social networks and eCommerce sites. This functionality, in turn, allows for the user to view other user generated content and be inspired in their own creations.

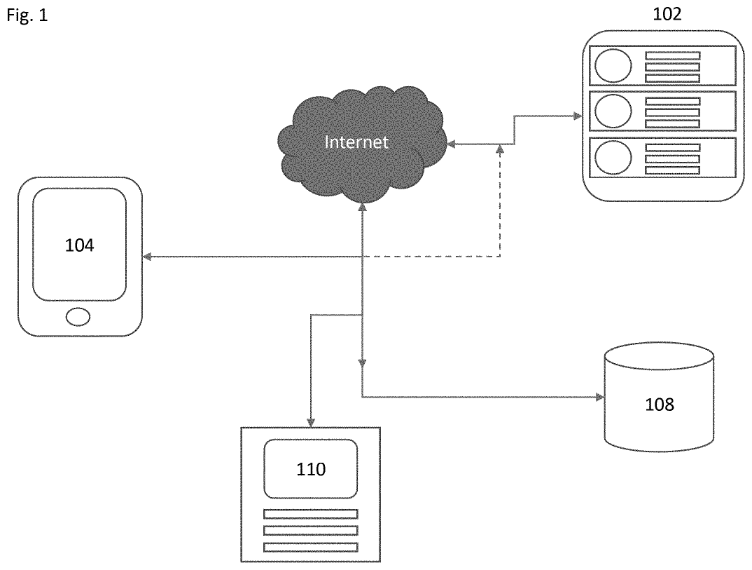

Turning now to the FIG. 1, the system, process and computer implemented methods are implemented by one or more hardware or software components that cooperate to implement the functionality described herein. For instance, and in no way limiting, the virtual environment and arrangement functionality described herein is implemented by one or more evaluation servers 102 that are configured to communicate with one or more user devices 104. In one or more implementations, the evaluation server 102 and/or user devices 104 are configured to access data, statically or dynamically, stored in one or more data storage devices, such as database(s) 108. In a further arrangement, the evaluation server 102 and user devices 104 are configured to communicate with one or more remote computing or accessing devices or servers 110, such as inventory management, commercial transaction, or goods production and shipping computers.

As used herein, “processor” or “computer” refers one or more electronic devices (e.g. semiconductor-based microcontrollers) configured with code in the form of software, to execute a given instruction set. For example, the evaluation server 102, database(s) 108, remote computing device 110 and user devices 104, include one or more processing or computing elements executing commercially available or custom operating system, e.g., MICROSOFT WINDOWS, APPLE OSX, UNIX or Linux based operating system implementations. In other implementations, evaluation server 102, database(s) 108 and user devices 104, remote access device 110 each include custom or non-standard hardware, firmware or software configurations. For instance, the processor or computer can include one or more of a collection of micro-computing elements, computer-on-chip, field programmable gate arrays, graphical processing units, home entertainment consoles, media players, set-top boxes, prototyping devices or “hobby” computing elements. Such computing elements described are connected, directly or indirectly, to one or more memory storage devices (memories) to form a microcontroller structure. The memory is a persistent or non-persistent storage device that is operative to store an operating system for the processor in addition to one or more of software modules. In accordance with one or more embodiments, the memory comprises one or more volatile and non-volatile memories, such as Read Only Memory (“ROM”), Random Access Memory (“RAM”), Electrically Erasable Programmable Read-Only Memory (“EEPROM”), Phase Change Memory (“PCM”), Single In-line Memory (“SIMM”), Dual In-line Memory (“DIMM”) or other memory types. Such memories can be fixed or removable, as is known to those of ordinary skill in the art, such as through the use of removable media cards or modules.

The computer memories may also comprise secondary computer memory, such as magnetic or optical disk drives or flash memory, that provide long term storage of data in a manner similar to the persistent memory device. In one or more embodiments, the memory of the processors (such as a processor of the evaluation server 102) provides for storage of application programs and data files when needed.

The processors or computers described are configured to execute code written in a standard, custom, proprietary or modified programming language such as a standard set, subset, superset or extended set of JavaScript, PHP, Ruby, Scala, Erlang, C, C++, Objective C, Swift, C#, Java, Assembly, Go, Python, Perl, R, Visual Basic, Lisp, TensorFlow for ML, mClust, or Julia or any other object oriented, functional or other paradigm based programming language.

In one particular implementation, the evaluation server 102 is a server, computing cluster, cloud platform or computing array, configured to directly, or through a communication linkage, communicate and exchange data with the one or more remote access devices 110, user devices 104 and/or databases 108.

As provided in the illustrated implementation, the evaluation server 102 is a computer server configured by code executing therein to accept electronic data queried from one of more remote data storage locations (e.g. database 108) and evaluate the queried or accessed data according to pre-determined or dynamic rules, logic, instructions or algorithms.

In a particular implementation, the evaluation server 102 is configured with one or more remote or local data storage devices that store operating code, as well as user information. The evaluation server 102 is also configured to access remote resources such as third-party vendor information, user data, and communication data from third parties through implementation of code modules.

As the implementation of FIG. 1 illustrates, the evaluation server 102 is used to evaluate the content of the database(s) and, based on evaluation of the content, generate new content or reference to particular content. For example, the content stored in the databases are transformed into visualizations suitable for a lay user to assess or comprehend the interactions between and among the data.

With particular reference to FIG. 1, the content database 108 is one or more datastores in communication with at least one processor of the evaluation server 102. The physical structure of the database(s) 108 may be embodied as solid-state memory (e.g., ROM), hard disk drive systems, RAID, disk arrays, storage area networks (“SAN”), network attached storage (“NAS”) and/or any other suitable system for storing computer data. In addition, the database 108 may comprise caches, including database caches and/or web caches. Programmatically, the database 108 may comprise flat-file data store, a relational database, an object-oriented database, a hybrid relational-object database, a key-value data store such as HADOOP or MONGODB, in addition to other systems for the structure and retrieval of data that are well known to those of skill in the art. The database 108 includes the necessary hardware and software to enable a processor local to the evaluation server 102 to retrieve and store data within the database 108.

With more particular reference to FIG. 1, the remote access devices 110 and user devices 104 are used to exchange data, such as electronic messages, data packages, streams or files, over a network to the evaluation server 102. In one implementation, the remote access device(s) 110 and user devices 104 connects to the evaluation server 102 directly, such through an internal local network (as shown in dashed lines). Alternatively, remote access devices 110 and user devices 104 connect to the evaluation server by first connecting to the Internet (as shown in solid lines).

As used herein, the remote access devices 110 and user devices 104 are a general or single purpose computing devices configured by hardware or software modules to connect to a network and receive data from the evaluation server 102. For example, the remote access device 104 is a personal communication device (smartphone, tablet computer, etc.), configured by one or more code modules to exchange data with the evaluation server 102. Remote access devices 110 and user devices 104 utilize wired or wireless communication means, such as, but not limited to CDMA, GSM, Ethernet, Wi-Fi, Bluetooth, USB, serial communication protocols and hardware to connect to one or more access points, exchanges, network nodes or network routers.

In one implementation, remote access devices 110 and user devices 104 are portable computing devices such as Apple iPad/iPhones®, Android® devices or other electronic devices executing a commercially available or custom operating system, e.g., MICROSOFT WINDOWS, APPLE OSX, UNIX or Linux based operating system implementations. In other implementations, remote access devices 110 and user devices 104 are, or includes custom or non-standard hardware, firmware or software configurations. Here, the remote access devices 110 and user devices 104 can communicate with the one or more remote networks using USB, digital input/output pins, eSATA, parallel ports, serial ports, FIREWIRE, Wi-Fi, Bluetooth, or other communication interfaces. In one or more configurations, the remote access devices 110 and user devices 104 are also configured, through hardware and software modules, to connect to more remote servers, computers, peripherals or other hardware using standard or custom communication protocols and settings (e.g., TCP/IP, etc.) either through a local or remote network or through the Internet.

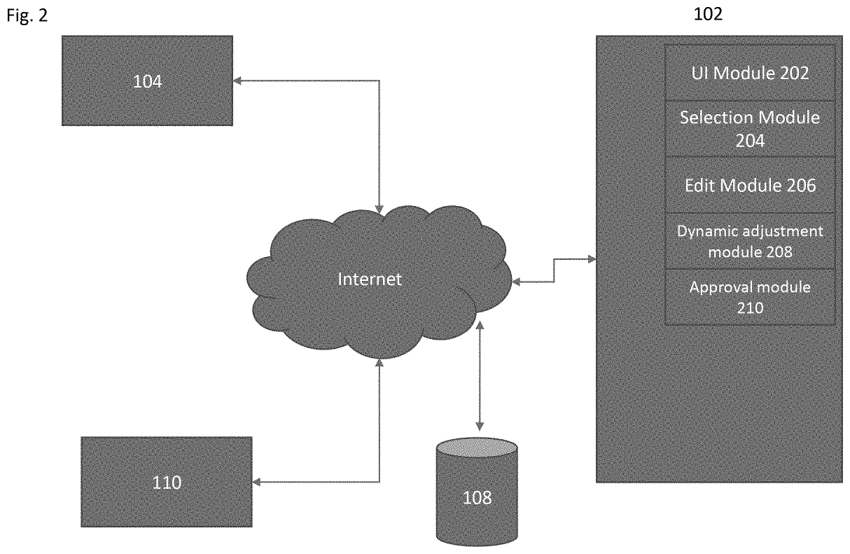

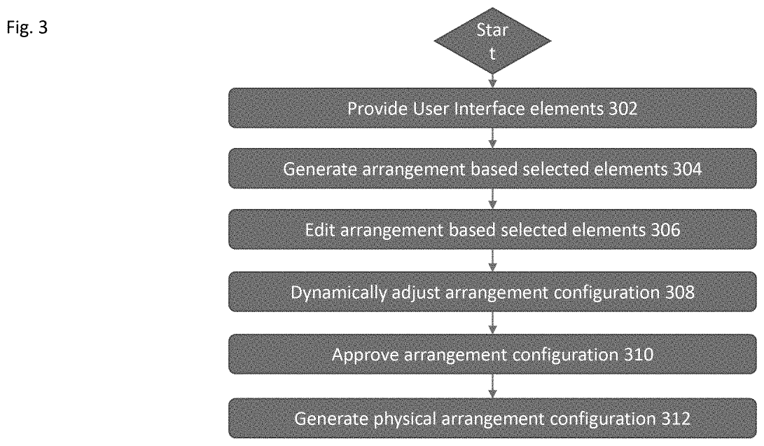

Turning now to FIGS. 2-3, a module diagram and flow diagram are provided detailing one or more steps carried out by a suitably configured processor of the system configured to evaluate, generate and display virtual arrangement or boutique items. As shown in step 302, a processor of the evaluation server 102 is configured to provide a user, using a user device 104, a user interface that allows the user to select or generate a virtual bouquet of products. For example, user interface module 202 configures the processor of the evaluation server 102 to generate and send to the remote user device 104 a collection of user interface elements that allows the user to select a particular item or collection of items for display in a virtual environment.

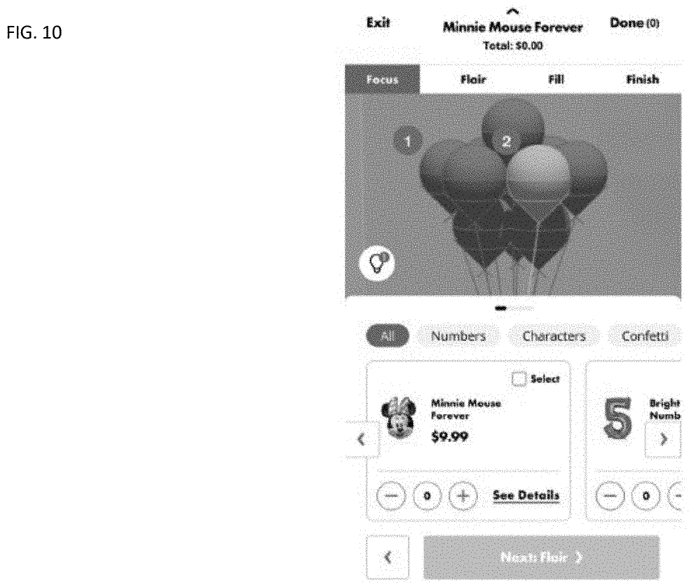

In one implementation, the processor is configured to present the user one or more preset or pre-determined collections of products (referred to as a virtual bouquet) based on the selected event type or theme. In this configuration, the virtual environment is updated to display the virtual bouquet within the virtual environment for the user's review. However, in one or more alternative configurations, such as shown in FIG. 10, the user is able to generate a new virtual bouquet from individual available product elements that are presented to the user. In this configuration, the virtual environment is updated to display the virtual bouquet within the virtual environment for the user's review. For example, the user is able to select one or more of the currently available virtual balloon elements. Here, a processor configured to provide access to an inventory management system that provides the user with virtual representations of physical goods that are available for purchase. These virtual goods, when selected, are incorporated into the virtual bouquet.

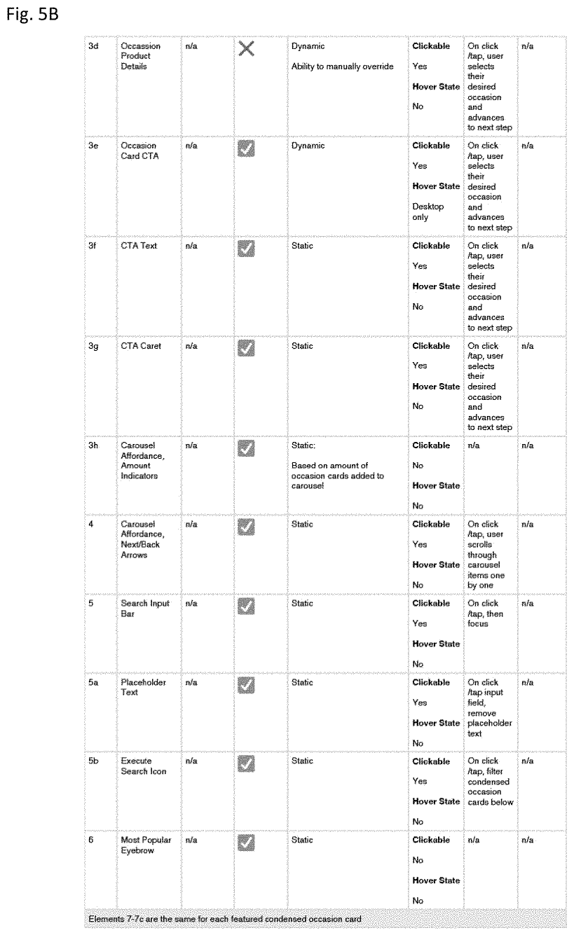

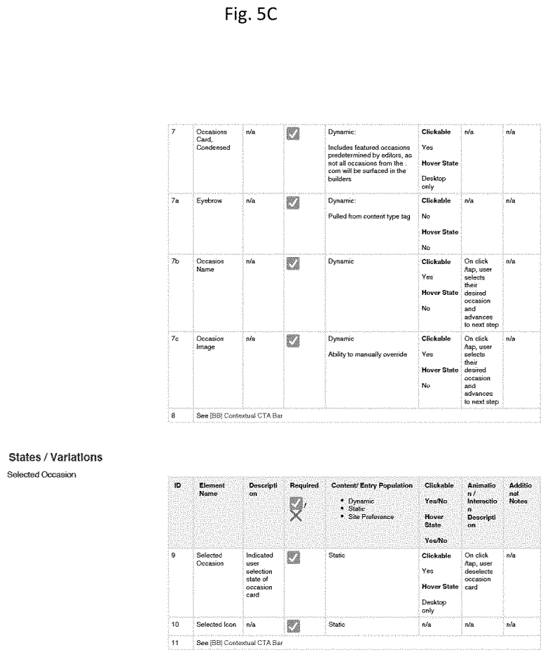

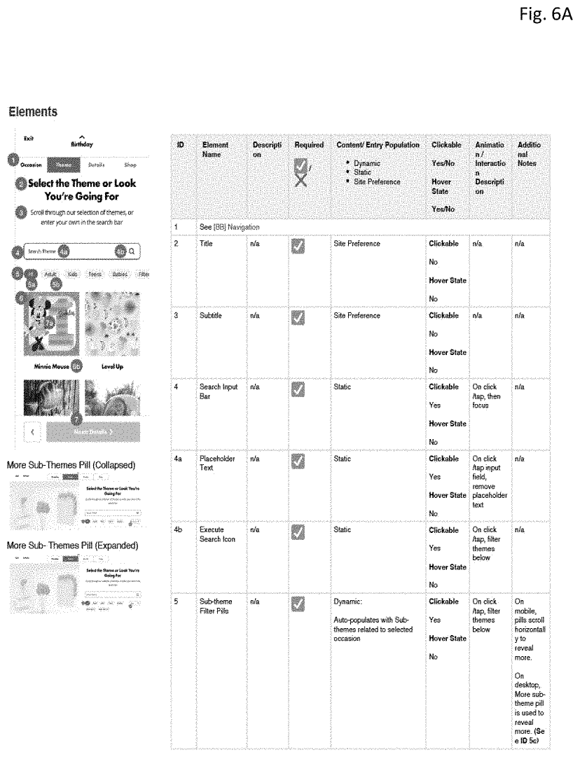

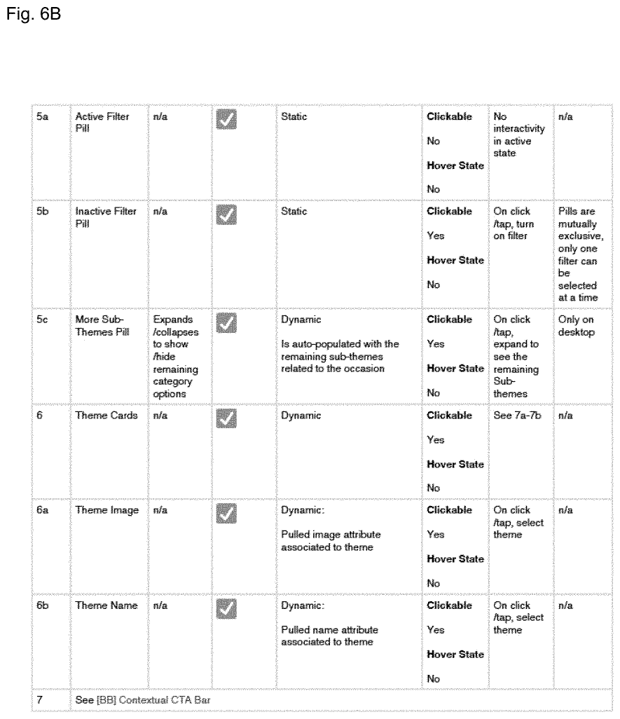

By way of further example, the user interface provided to the user device 104 in step 302 includes a number of selectable themes or styles presented as user interface elements, as shown in FIGS. 5A-5C, (For example, elements 1-8). Here, the user is able to interact with these user interface elements and cause the processor to update or alter the user interface to continue with the virtual bouquet or arrangement selection and generation process.

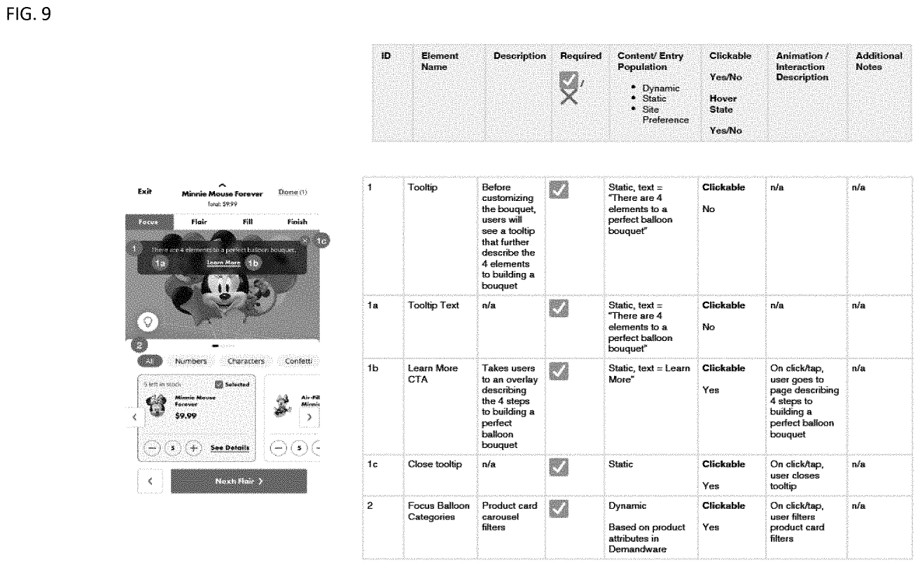

In one or more particular implementations, a processor of the evaluation server 102 is configured by one or more modules executing as code therein to present a user with one or more event types provided as user interface elements. For example, as shown in FIG. 9, upon receiving an event type selection from the user, a processor of the described system is then configured to generate a virtual environment for display to the user where in the virtual environment displayed corresponds to the event type selection.

As further shown with respect to elements 1a-2 in FIG. 9, a processor of the described system is further configured to generate or permit access to an inventory management system obtain an array of available products having a corresponding virtual environment representation. In one or more implementations, the available products included within the array have been pre-tagged or coded as corresponding to the selected event type. For example, again with reference to FIG. 9, where the event type involves a particular cartoon character, accessory elements (such as other balloons) sharing the same character theme or source material are presented as user interface elements. These user interface elements are selectable, and upon selection, cause the inclusion of the referenced product into the virtual display.

In one or more implementations, the array of products that are displayed to the user are generated based on existing rules or associations within a product management system. However, in alternative configurations, the array of available products displayed to the user are selected or based on or more machine learning models configured to evaluate the product given the event type and determine the likelihood that the available product is suitable for use in the selected event type. For example, given the size, shape or color of the user's initial selection, a selection model is configured to evaluate the available inventory to identify one or more complementary products. For example, a complementary product can be selected based on complementary colors according to color theory or other arrangement algorithms. The processor in this arrangement is further configured to transform the array of available products identified by such a machine learning model into interactable user elements for display to the user.

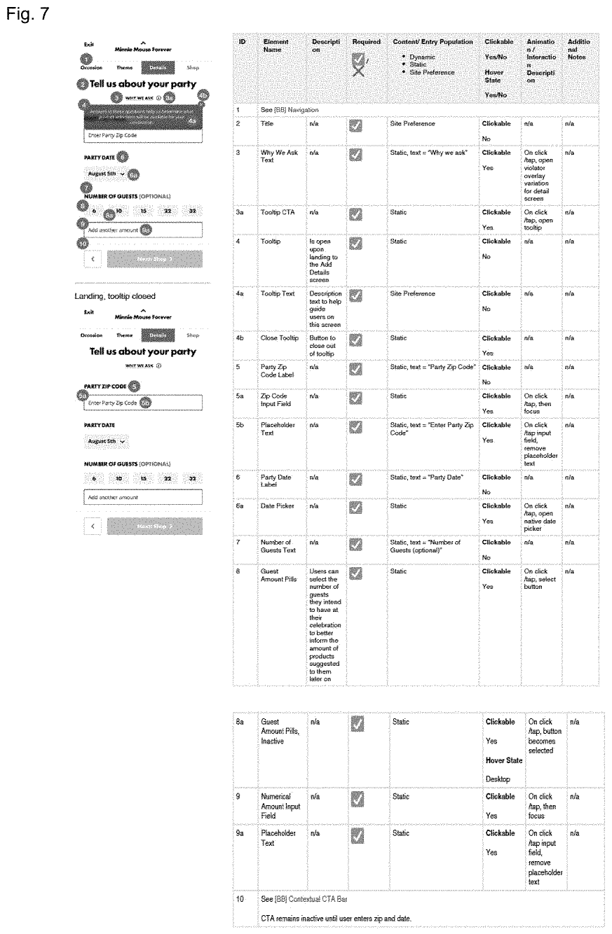

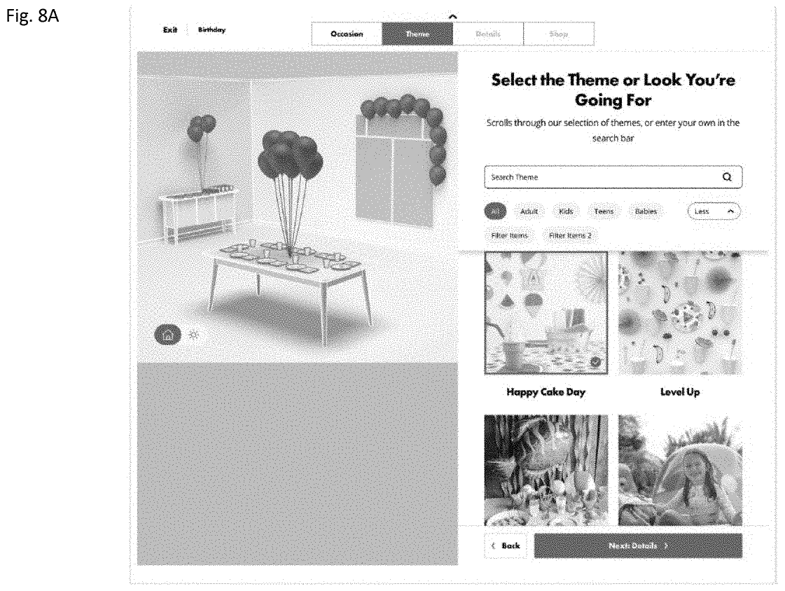

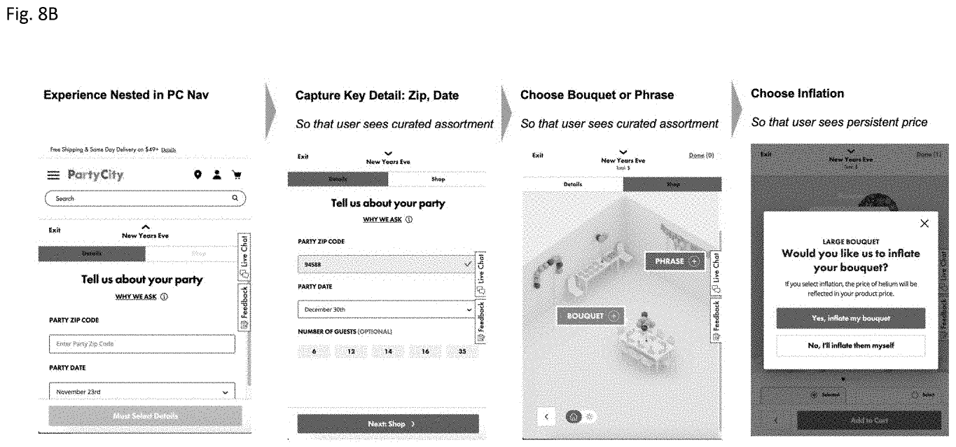

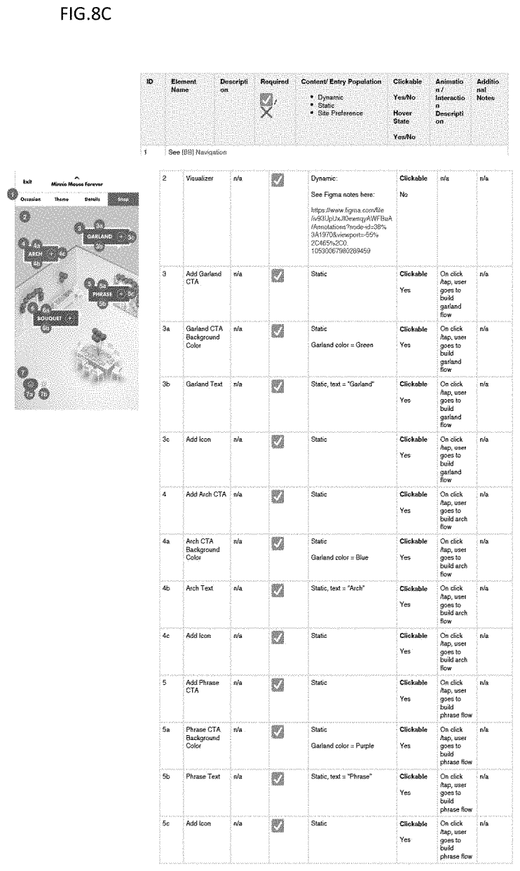

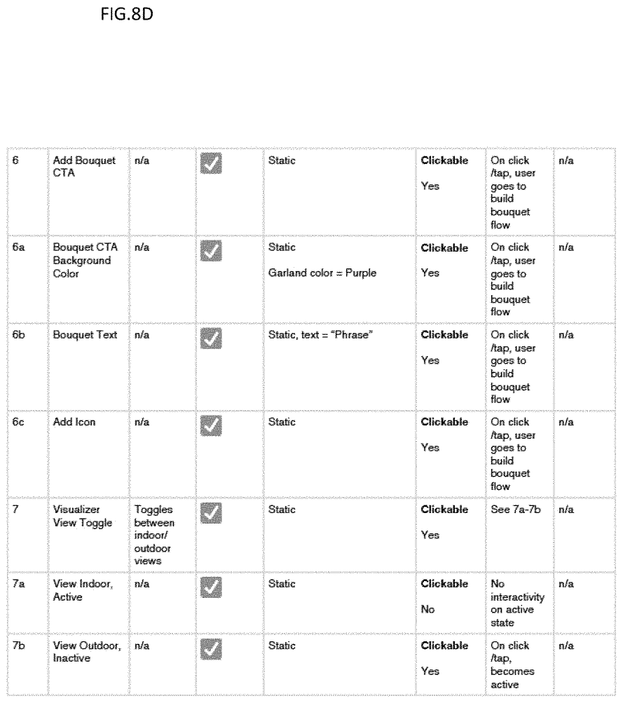

As shown in FIGS. 7 and 8A-8C, the selection process can be expanded beyond a single product bouquet. For instance, as shown in FIGS. 7 and 8A, the user can be presented with a theme or style for an entire room. Here, a virtual environment that corresponds to an event space (such as a dining room) is provided with virtual elements that correspond to a selection of potential celebration events. For instance, a processor of the described system is configured to provide an array of event types or themes (such as a birthday party) from a pre-determined event listing. In one particular implementation, the event type is a birthday, religious holiday, national holiday or a specialty event (such as a sporting event). In one or more further implementations, the user selection element corresponds to particular themes or looks that the user would like to implement for the given event.

As further shown in FIG. 8B, the user is presented with a selection of event parameters, such as number of guests. Upon selection of these parameters, the processor of the evaluation server is configured to update or generate a virtual environment that has the requisite number of elements for the established parameters. For instance, where the user selects 12 guests as the number of guests attending an event, a virtual representation of a table having at least 12 table settings is generated and displayed within the virtual environment.

As shown in FIG. 8C, in addition to a virtual bouquet, additional items for an event are also displayed and are selectable as user interface elements (see elements 1-7b). For example, other event elements, such as balloon arches, garland, banners, table settings, and the like (as shown in FIG. 8C) can be selected, arranged and dynamically adjusted according to the forgoing disclosure.

In one or more further implementations, the processor is configured to allow the user to edit the appearance of the virtual bouquet. For example, in one or more configurations, custom text or illustrations can be added to the surface of one or more of the balloon elements of the virtual bouquet. For example, as shown in FIGS. 5A-C, and 6A-6B, the user elements are interactive and allow for dynamic configurations based on user selection. In one or more particular implementations, the user interface elements provided to the user in step 302 are dependent on the availability of one or more elements that comprise the bouquet. For instance, where one or more balloon elements is not in stock, the user interface presented to the user in step 302 will not provide one or more pre-determined bouquets that utilize those elements. In one or more implementations, the user interface module 202 configures the processor of the evaluation server 102 to query an inventory management system (such as remote computer 110) to determine if one or more elements of the pre-arranged bouquet are available for purchase or generation. Where one or more elements are not available for purchase or generation, the user interface module 202 configures the processor of the evaluation server 102 to omit that pre-arranged bouquet from the user interface presented to the user.

As shown in step 304, a processor of the described system is configured to receive one or more user selections from the remote device 104. Here, the user selections can be a selection of a user interface element that corresponds to a pre-made or arranged bouquet (as shown in FIGS. 5A-C, and 6A-6B). Alternatively, the user interface elements selected can relate to a blank or base bouquet that the user will customize with additional elements (as shown in FIG. 10). For instance, the selection module 204 configures a processor of the evaluation server 102 to generate a pre-arranged bouquet in response to a user interface selection of a corresponding element. For example, the selection module 204 causes a processor of the evaluation server 102 to access one or more stored data values corresponding to a pre-determined virtual bouquet. Using this bouquet data, the processor is configured to generate the bouquet within a 3-dimensional virtual environment.

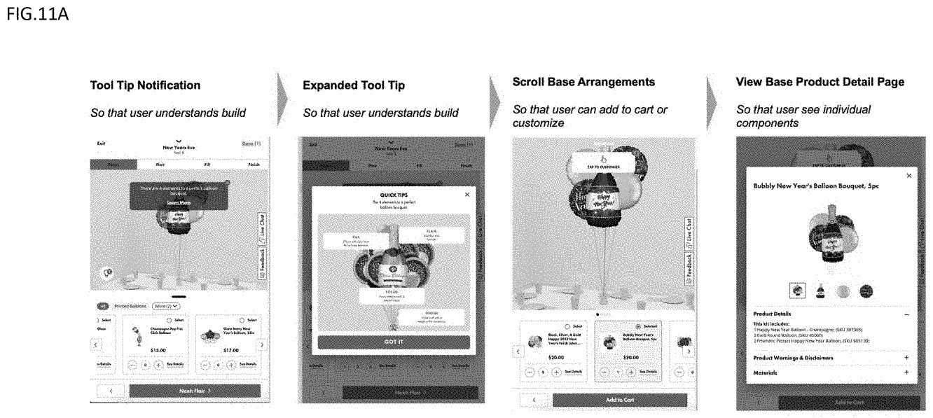

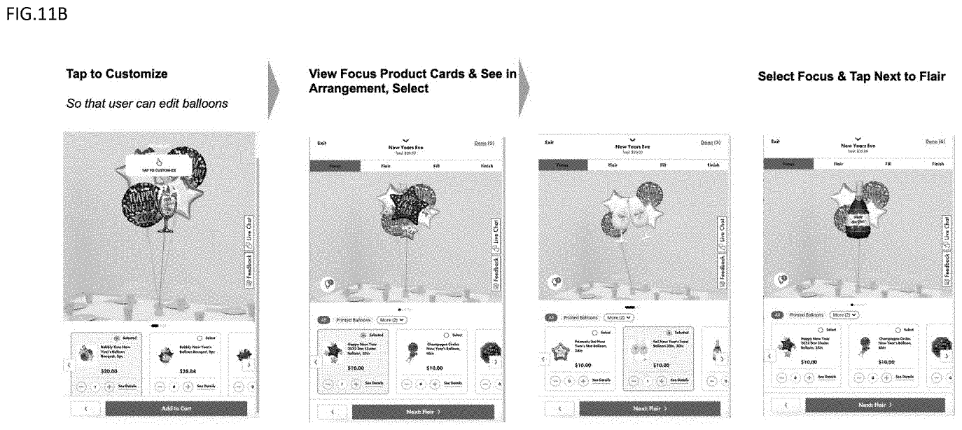

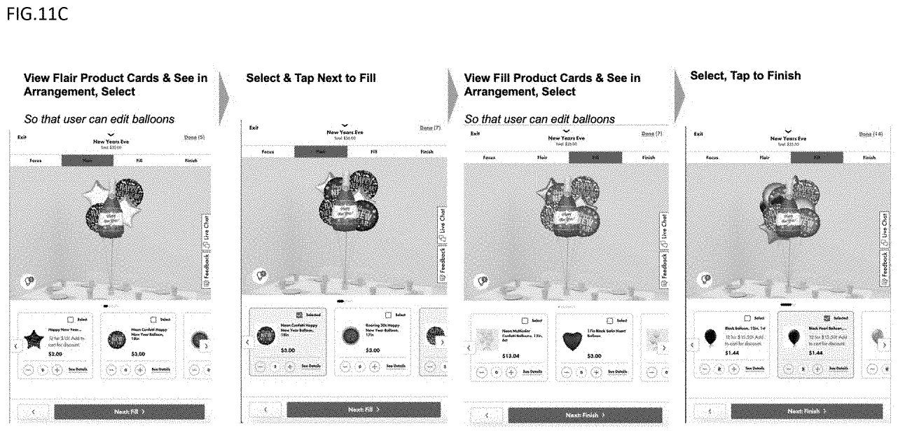

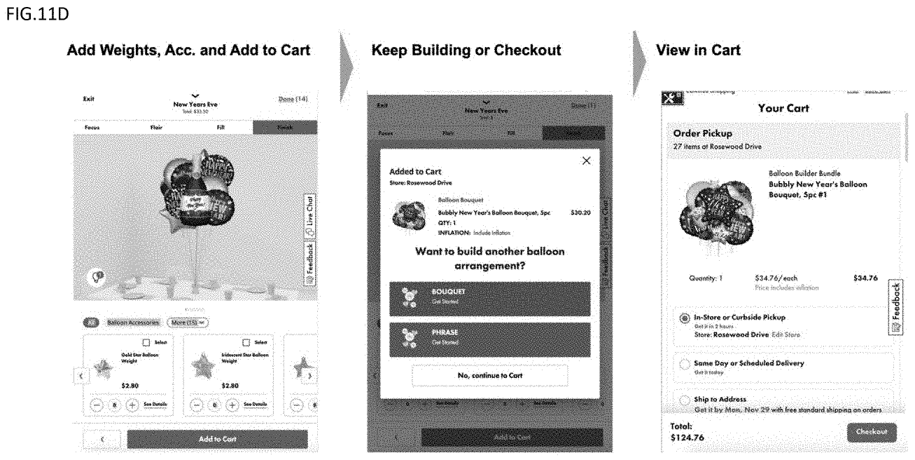

In one or more particular implementations, the 3-dimensional virtual environment is presented to the user with the virtual bouquet located within the 3-dimensional virtual environment. As shown in step 306, the user is able to adjust the virtual bouquet within the 3-dimensional virtual environment. For example, the user is presented with additional potential selection items. Here, additional balloons, banners, strings, or other elements can be added to the 3-dimensional virtual environment. In one or more particular implementations, the additional elements added to the virtual environment are added using a basic or generic element. In another particular implementation, the additional elements added to the 3-dimensional environment can be customized for color, shape, or other characteristics. In a further implementation, the user is able to add text or illustrations to the depicted virtual elements. For example, as shown in FIGS. 11A-11D, the user can customize individual balloon elements (as shown in 11B).

In one or more implementations, the additional elements added, as in step 306, to the virtual display can obscure or overwhelm the virtual bouquet. As such, the processor of the evaluation server 102 is configured to alter the arrangement and configuration of the elements within the virtual bouquet as shown in step 308. For example, the dynamic adjustment module 208 configures the processor of the evaluation server 102 to dynamically alter the arrangement of the elements of the bouquet within the 3-dimensional space to ensure that a portion of the face of each balloon element is visible to a virtual viewer or camera.

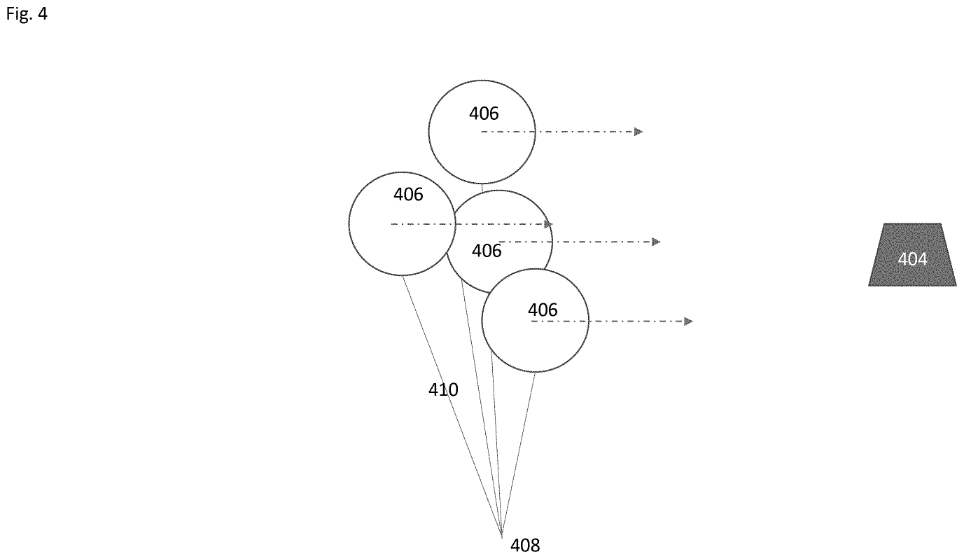

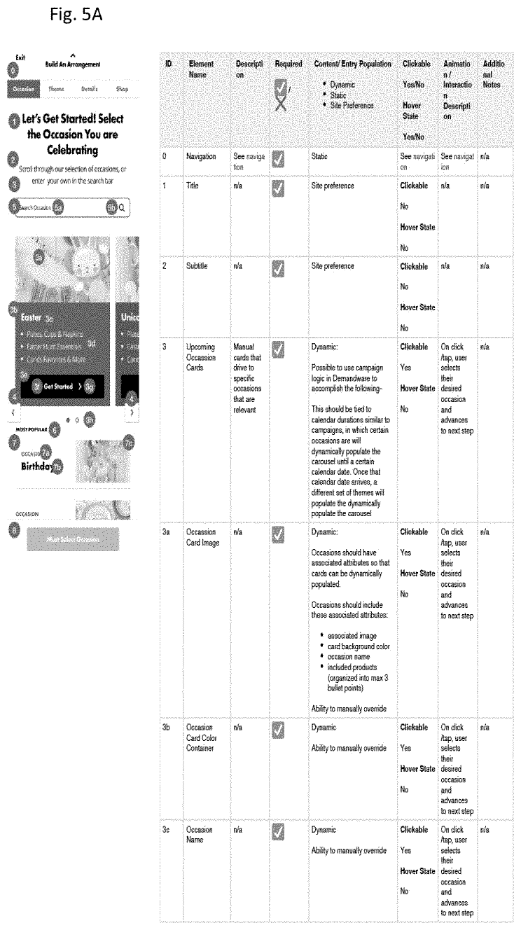

For example, with particular reference to FIG. 4, a virtual viewer or camera 404 is used to view the virtual bouquet. In arrangements that have been overloaded, some or all of the balloon elements (406) are obscured from view of the virtual camera. In response, the dynamic adjustment module 208 is configured to alter the arrangement of the balloon elements 406 so as to ensure that at least a portion of each balloon element is visible by the virtual camera 404. It will be appreciated that when the virtual balloon is represented by physical product, the same arrangement will produce the same visual effect. For example, the virtual camera can be adjusted to depict the virtual arrangement from the point of view of a smaller individual, such as a child or a person sitting. Alternatively, the virtual camera can be adjusted to represent the view of a person standing, of above average, or any specified height. In this way the dynamic adjustment of the virtual bouquet is related to the intended viewing position. Therefore, by dynamically altering the configuration in the virtual environment, the user is able to ensure that the physical display will have the same visual configuration for the intended viewer.

The dynamic adjustment module 208 is configured to monitor the arrangement of the virtual bouquet and adjust the arrangement in response to additional elements being added or removed from the bouquet. By way of non-limiting example, upon addition of a new element to the virtual bouquet or event space, the processor of the evaluation server 102 is configured to dynamically alter the virtual bouquet or event space representation within the virtual environment so as present a realistic depiction of the generated bouquet. As shown in FIG. 4, each virtual element (such as balloon element 406) in the bouquet is represented independently. In this virtual representation, each balloon element, in addition to its three-dimensions shape, has a point of attachment to a base 408, with an attachment length represented by a straight line 410.

In one or more particular implementations, the parameters of one or more balloon elements of the virtual bouquet are adjusted so that a portion of each balloon element is visible to the user. For example, where the processor is configured to display the virtual bouquet in a virtual environment at a certain height, such as the height of the virtual camera 404, the dimensions of each balloon are taken into account. Likewise, where the virtual balloons are likely to overlap one another, the attachment length (such as a virtual representation of a string 410) is increased or decreased automatically to allow for greater visibility.

In one particular implementation, using the known dimensions of each virtual balloon, the processor is configured by the dynamic adjustment module 208 to calculate a center one of each balloon element. The center (which, in one or more implementations, corresponds to the center of the balloon shape) of each virtual balloon is then determined. Using the center point, a view path (as shown in dashed line) can be aligned with the center point of each balloon. As shown, the processor configured by the dynamic adjustment module 208 can alter the lengths of the of the attachment (410) so as to ensure that each center view line (or other desired view line) is not obstructed by another balloon element in the virtual bouquet. For example, where the center line of a first and second balloon element are closely aligned (both vertically and horizontally) in the 3-dimensional environment, the processor can determine that the balloons are overlapping. By increasing or decreasing the attachment length of one or both of the closely aligned balloons, the center lines can be made to separate. This separation results in more of each balloon being visible to the virtual camera, and ultimately, the end user in the actual physical arrangement.

In another arrangement, a processor is configured by the dynamic adjustment module 208 to adjust or alter the element selected for inclusion or another element within the virtual bouquet. For example, the processor of the evaluation server 102 is configured by the dynamic adjustment module 208 to alter the dimensions of a given balloon element to ensure visibility. For example, where the inventory management system includes information on multiple sizes of the same style or color of balloon, the processor of the evaluation server 102 is configured to substitute a different sized balloon where the processor has determined that view lines will be obstructed.

Once the processor has received all of the user's selections and customizations, the user can send a purchase order to the processor for processing the user's account transaction. For instance, as shown in step 310, the user can approve all of the elements added to, modified, or relating to the bouquet or arrangement. As part of the approval process, the user is able to submit a purchase transaction that causes the processor configured by the approval module 210 to process a payment for the items represented within the virtual environment.

As part of the approval process, (as shown in FIGS. 11A-11D), the approval module 310 configures the processor to generate a data object or data file that includes all of elements of the arrangement or bouquet as generated in steps 306-308. For instance, where the bouquet or arrangement includes balloons with different attachment lengths, the processor is configured to generate a datafile that includes the dynamically generated attachment lengths, colors, sizes, and other criteria for the arrangement.

Once the user has selected or generated a virtual bouquet or arrangement that meets the needs of the user, the processor translates the virtual bouquet into one or more instructions or instruction sets that can be provided to one or more manually or automatically operated product production facilities. Here, one or more remote computers or servers, such as remote computer 110, are configured to receive data files and implement physical production of the elements of the virtual bouquet. In one or more particular implementations, an automatic product manufacturing process is used to generate each of the individual components of the bouquet, which are then packaged and transported to the end user for assembly in accordance with the data file that corresponds to the virtual representation.

In a further implementation, the generated datafile will include the custom text or images for display on the face of one or more balloons. Additionally, the datafile in one or more implementations, stores the relevant details for the length of any attachment elements. In one or more implementations, upon approval and payment, the datafile is sent to one or more local or remote processing facilities. For example, a copy of the datafile is sent to one or more balloon printing devices, which is able to parse the datafile and generate the custom text on the desired balloon.

In one or more further implementations the datafile or data list can instruct a ribbon or string production device to generate a ribbon or string of the desired length as an attachment device for one or more of the balloons. Here the production list includes the length of the attachment line as determined by the processor during the dynamic adjustment process of step 308.

While this specification contains many specific embodiment details, these should not be construed as limitations on the scope of any embodiment or of what can be claimed, but rather as descriptions of features that can be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features can be described above as acting in certain combinations and even initially claimed as such, one or more features from a claimed combination can in some cases be excised from the combination, and the claimed combination can be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system components in the embodiments described above should not be understood as requiring such separation in all embodiments, and it should be understood that the described program components and systems can generally be integrated together in a single software product or packaged into multiple software products.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

It should be noted that use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements. Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

Particular embodiments of the subject matter described in this specification have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain embodiments, multitasking and parallel processing can be advantageous.

Publications and references to known registered marks representing various systems cited throughout this application are incorporated by reference herein. Citation of any above publications or documents is not intended as an admission that any of the foregoing is pertinent prior art, nor does it constitute any admission as to the contents or date of these publications or documents. All references cited herein are incorporated by reference to the same extent as if each individual publication and references were specifically and individually indicated to be incorporated by reference.

While the invention has been particularly shown and described with reference to a preferred embodiment thereof, it will be understood by those skilled in the art that various changes in form and details may be made therein without departing from the spirit and scope of the invention. As such, the invention is not defined by the discussion that appears above, but rather is defined by the claims that follow, the respective features recited in those claims, and by equivalents of such features.

What is claimed is:

1. A virtual arrangement generation processes, the process comprising:
sending, to a remote user, a collection of user interface elements, wherein each user interface element corresponds to a physical product available for sale for incorporation into an event display;
receiving from the remote user, a first selection of at least one user interface element;
generating a virtual, 3-dimensional environment, wherein the environment includes a virtual representation of the at least one physical product corresponding to the first selected user interface;
displaying to the remote user, the generated virtual 3-dimensional environment;
receiving a request from the user to add at least one additional representation of at least one additional physical product to the virtual environment;
adjusting at least one parameter of the added at least one additional representation of at least one additional physical product, wherein the adjustment is selected to enhance the visibility of at least the first selection of the virtual representation of the at least one physical product, and at least one additional representation relative to an unenhanced arrangement;
generating a datafile including each representation of the at least one physical product depicted within the virtual environment, wherein the datafile includes the adjusted parameter for the at least one additional representation of the at least one additional physical product; and

2. The process of claim 1, further comprising sending to the datafile to at least one remote production device, wherein the production device is configured to receive the datafile and generate the corresponding physical product, wherein the physical product has the parameters provided in the generated datafile.

3. The process of claim 1, wherein adjusting includes determining a center point of a plurality of virtual representations of visual products and aligning the determined center point with a virtual camera.

4. The process of claim 1, where adjusting includes altering the length of an attachment element connecting a virtual representation of a product to a common anchor point.

5. The process of claim 3, wherein the virtual representation of a product is a virtual balloon.

6. A system for generating virtual arrangements, the system comprising:
A processor having memory and configured to:
send, to a remote processor configured with a display and an interface, a collection of user interface elements for display on the display, wherein each user interface element corresponds to a physical product available for sale for incorporation into an event display;
receive from the remote processor, a first selection of at least one user interface element;
generate a virtual, 3-dimensional environment, wherein the environment includes a virtual representation of the at least one physical product corresponding to the first selected user interface;
display the generated virtual, 3-dimensional environment on the display of the remote processor;
receive a request from the user to add at least one additional representation of at least one additional physical product to the virtual environment;
adjust at least one parameter of the added at least one additional representation of at least one additional physical product, wherein the adjustment is selected to enhance the visibility of at least the first selection of the virtual representation of the at least one physical product, and at least one additional representation relative to an unenhanced arrangement;
generate a datafile including each representation of the at least one physical product depicted within the virtual environment, wherein the datafile includes the adjusted parameter for the at least one additional representation of the at least one additional physical product; and

7. The system of claim 6, wherein the processor is configured to send to the datafile to at least one remote production device, wherein the production device is configured to receive the datafile and generate the corresponding physical product, wherein the physical product has the parameters provided in the generated datafile.
